(19) United States
(12) Patent Application Publication
(10) Pub. No.: US 2005/0213945 A1
(43) Pub. Date: Sep. 29, 2005

(54) Audio-visual recording/playback apparatus and digital video camera

(76) Inventors: Toshihisa Ohiro, Ehime (JP); Taisuke Tsurui, Ehime (JP); Takami Uemura, Ehime (JP); Yoichi Hida, Ehime (JP)

Correspondence Address: WENDEROTH, LIND & PONACK, L.L.P., 2033 K STREET N. W., SUITE 800, WASHINGTON, DC, 20006-1021, US

(21) Appl. No.: 11/088,842

(22) Filed: Mar. 25, 2005

(30) Foreign Application Priority Data
Mar. 25, 2004 (JP) 2004-090237
Mar. 22, 2005 (JP) 2005-082651

(51) Int. Cl. H04N 5/76; H04N 5/225

(52) U.S. Cl. 386/98; 386/117

(57) ABSTRACT

An audio-visual recording/playback apparatus having an image pickup unit for capturing video and audio, comprises a compression unit for generating streams from data captured by the image pickup unit, a stream multiplexing unit for multiplexing the streams, and a recording medium on which the streams are recorded. A plurality of streams are generated from a signal captured by the image pickup unit, the plural streams are multiplexed, and the multiplexed stream is recorded. Therefore, when playing the recorded streams using a common player, a viewer can select and play his/her favorite video while continuing playback of audio as it is.

### FIELD OF THE INVENTION

The present invention relates to an audio-visual recording/playback apparatus and a digital video camera using DVD recording/playback discs. More particularly, the invention relates to an audio-visual recording/playback apparatus and a digital video camera for generating plural streams from a single input video to a camera of a disc movie, multiplexing the streams, and recording the multiplexed stream in recording media.

### BACKGROUND OF THE INVENTION

In recent years, DVDs in which video and audio are digital-compressed and recorded have become widespread, and are widely used for DVD recorders for recording TV broadcasts and disc movies using DVDs as recording media. While a VTR which has conventionally been used can play back, at most, recorded data in the recorded order from the beginning, a DVD can provide a function of playing a desired scene in a moment, a function of easily performing edits, and the like.

There is the MPEG (Moving Picture Experts Group) as an information compression technique for efficiently storing and transferring video and audio. In the MPEG, the construction of signals used for multiplexing a plurality of digital signals as elements constituting digital contents such as video and audio are multiplexed into a bit stream is defined as a system standard. Further, in order to record a moving picture, a DVD video standard is defined, which is an application format including such as a file name, a directory structure, and a data form, thereby enabling recording into recording media such as a DVD-R. The DVD video standard provides information data for supporting trick plays such as fast forward, rewind, and the like, thereby making the trick plays smooth. Further, the DVD video standard defines a multi-angle function for arbitrarily selecting one from among plural angles of videos, which enables the user to select his/her favorite angle of video while playing audio as it is.

There is a conventional method for recording video and audio in a disc utilizing the above-mentioned multi-angle function, which method includes receiving video and audio through plural inputs, performing compression while maintaining synchronization, and recording the video and audio in a recording medium as a multi-angle stream in realtime (refer to Japanese Published Patent Application No. Hei.11-103444 (pages 2-5, FIG. 1)).

Conventionally, digital video cameras using tape media have become widespread as video cameras. However, when playing back data recorded in a tape medium using the digital video camera, it is difficult to instantaneously play a desired scenes and further, it is also difficult to edit the recorded data. In order to solve these problems, disc movies using recording media such as a DVD-R, a DVD-RAM, and the like have increasingly been spread in recent years, thereby facilitating editing or the like.

However, although it is possible to instantaneously play a desired scene when playing video shot by the disc movie, it is not possible to play video desired by the viewer while continuously playing audio as it is.

For example, it is assumed that the state of a lecture meeting in which materials are projected onto a screen utilizing a liquid crystal projector or an OHP and a presenter performs presentation is shot by using a disc movie. When the figure of the presenter and the materials of the presentation are alternately shot in the recorded video, the viewer who plays and views the recorded video may sometimes want to view not the recorded video of the scene in which the figure of the presenter is shot but the recorded video of the materials of the presentation, while continuously playing the audio of the presenter's lecture as it is.

So, it is considered that the multi-angle function of the DVD video standard is utilized when performing shooting with the disc movie to perform multi-angle recording on the disc, so that the viewer can view the recorded video with his/her favorite scene and camera angle when playing the recorded video. While the Japanese Published Patent Application No. Hei.11-103444 provides a recording apparatus performing multi-angle recording in realtime, it requires multiple channels of inputs, and therefore, is inapplicable to an apparatus having a single input such as a disc movie.

### SUMMAY OF THE INVENTION

The present invention is made to solve the above-described problems and has for its object to provide an audio-visual recording/playback apparatus and a digital video camera which are able to generate a plurality of streams from an input video, perform multiplexing of the streams, and record the multiplexed stream on a recording medium.

Other objects and advantages of the invention will become apparent from the detailed description that follows. The detailed description and specific embodiments described are provided only for illustration since various additions and modifications within the scope of the invention will be apparent to those of skill in the art from the detailed description.

According to a first aspect of the present invention, there is provided an audio-visual recording/playback apparatus having an input means for capturing an audio-visual signal, comprising: a stream generation unit for generating plural streams using one audio-visual signal inputted by the input means; a multiplexing unit for multiplexing at least two streams among the plural streams to generate a multiplexed stream; and a recording unit for recording the multiplexed stream.

According to a second aspect of the present invention, there is provided an audio-visual recording/playback apparatus having an input means for capturing an audio-visual signal, comprising: a stream generation unit for generating plural streams using one audio-visual signal inputted by the input means; a multiplexing unit for multiplexing the plural streams to generate a multiplexed stream; a recording unit for recording the multiplexed stream; and the stream generation unit generating the plural streams as those using the same audio.

According to a third aspect of the present invention, in the audio-visual recording/playback apparatus according to the first or second aspect, the stream generation unit generates, as one of the plural streams, a first stream using a normal moving picture of the audio-visual signal inputted by the input means, and generates, as another one of the plural streams, a second stream using still pictures of the audio-visual signal inputted by the input means; and the multiplexing unit multiplexes the first stream and the second stream which are generated by the stream generation unit.

According to a fourth aspect of the present invention, in the audio-visual recording/playback apparatus according to the first or second aspect, the stream generation unit generates, as one of the plural streams, a first stream using a normal moving picture of the audio-visual signal inputted by the input means, and generates candidate still pictures from the first stream, and generates, as another one of the plural streams, a second stream using a still picture selected from among the candidate still pictures; and the multiplexing unit multiplexes the first stream and the second stream which are generated by the stream generation unit.

According to a fifth aspect of the present invention, in the audio-visual recording/playback apparatus according to the fourth aspect, the candidate still pictures are still pictures which are extracted at predetermined time intervals from the stream generated using the normal moving picture of the audio-visual signal.

According to a sixth aspect of the present invention, in the audio-visual recording/playback apparatus according to the fourth aspect, the candidate still pictures include still pictures at points in time when the scene of the stream generated using the normal moving picture of the audio-visual signal changes.

According to a seventh aspect of the present invention, in the audio-visual recording/playback according to the fourth aspect, the candidate still pictures are still pictures which are obtained by a predetermined time earlier than a silence period of the stream generated using the normal moving picture of the audio-visual signal, or still pictures obtained during the silence period, or still pictures which are obtained by a predetermined time later than the silence period.

According to an eighth aspect of the present invention, the audio-visual recording/playback apparatus according to the fourth aspect comprises a zoom unit for performing a zoom operation including zoom-in and zoom-out, and the candidate still pictures are still pictures which are obtained by a predetermined time earlier than start of the zoom operation, or still pictures obtained during the zoom operation, or still pictures which are obtained by a predetermined time later than end of the zoom operation.

According to a ninth aspect of the present invention, the audio-visual recording/playback apparatus according to the first aspect comprises a still picture capture unit for directly capturing still pictures from the outside; the stream generation unit generates, as one of the plural streams, a first stream using a normal moving picture of the audio-visual signal inputted by the input means, and generates, as another one of the plural streams, a third stream using the still pictures which are captured by the still picture capture unit; and the multiplexing unit multiplexes the first stream and the third stream which are generated by the stream generation unit.

According to a tenth aspect of the present invention, the audio-visual recording/playback apparatus according to the first or second aspect comprises a still picture capture unit for directly capturing still pictures from the outside; the stream generation unit generates, as one of the plural streams, a first stream using a normal moving picture of the audio-visual signal inputted by the input means, and generates candidate still pictures from the still pictures captured by the still picture capture unit, and generates, as another one of the plural streams, a third stream using a still picture selected from among the candidate still pictures; and the multiplexing unit multiplexes the first stream and the third stream which are generated by the stream generation unit.

According to an eleventh aspect of the present invention, in the audio-visual recording/playback apparatus according to the third aspect, the multiplexing unit multiplexes the first stream and the second stream, starting from a time when the still picture is generated from the audio-visual signal inputted by the input means.

According to a twelfth aspect of the present invention, in the audio-visual recording/playback apparatus according to the ninth aspect, the multiplexing unit multiplexes the first stream and the third stream, starting from a time when the still picture is generated from the audio-visual signal inputted by the input means.

According to a thirteenth aspect of the present invention, in the audio-visual recording/playback apparatus according to the fourth aspect, the multiplexing unit multiplexes the first stream and the second stream, starting from a time when the still picture is selected from among the candidate still pictures.

According to a fourteenth aspect of the present invention, in the audio-visual recording/playback apparatus according to the tenth aspect, the multiplexing unit multiplexes the first stream and the third stream, starting from a time when the still picture is selected from among the candidate still pictures.

According to a fifteenth aspect of the present invention, in the audio-visual recording/playback apparatus according to the fourth aspect, the recording unit is able to record the still picture selected from among the candidate still pictures, and the stream generated from the still picture.

According to a sixteenth aspect of the present invention, in the audio-visual recording/playback apparatus according to the tenth aspect, the recording unit is able to record the still pictures captured by the still picture capture unit, and the stream generated from the still pictures.

According to a seventeenth aspect of the present invention, there is provided a digital video camera having an input means for capturing an audio-visual signal, comprising: a stream generation unit for generating plural streams using one audio-visual signal inputted by the input means; a multiplexing unit for multiplexing the plural streams to generate a multiplexed stream; a recording unit for recording the multiplexed stream; and the stream generation unit generating the plural streams as those using the same audio.

According to the audio-visual recording/playback apparatus and the digital video camera of the present invention, a plurality of streams are generated using a single input, and multi-angle recording of the streams is carried out. Therefore, when playing recorded video and audio with a common player such as a DVD player, it is possible for the viewer to select and play his/her favorite video while continuing playback of audio as it is.

### BRIEF DESCRIPTION OF THE DRAWINGS

FIG. 1 is a block diagram illustrating an audio-visual recording/playback apparatus according to a first embodiment of the present invention.

FIG. 2 is a diagram illustrating the construction of a compressed stream employed in the audio-visual recording/playback apparatus according to the first embodiment.

FIG. 3 is a diagram illustrating a stream multiplexing format employed in the audio-visual recording/playback apparatus according to the first embodiment.

FIG. 4 is a diagram illustrating, in detail, a liquid crystal display included in the audio-visual recording/playback apparatus according to the first embodiment.

FIG. 5 is a diagram illustrating, in detail, a liquid crystal display included in the audio-visual recording/playback apparatus according to the first embodiment.

FIG. 6 is a conceptual diagram illustrating a flow of time from when a user selects a still picture to when multi-angle recording is started, in the audio-visual recording/playback apparatus according to the first embodiment.

FIG. 7 is a conceptual diagram illustrating a flow of time from when a user selects a still picture to when multi-angle recording is started, in the audio-visual recording/playback apparatus according to the first embodiment.

FIG. 8 is a flowchart for performing multi-angle recording by the audio-visual recording/playback apparatus according to the first embodiment.

### DETAILED DESCRIPTION OF THE PREFERRED EMBODIMENTS

### Embodiment 1

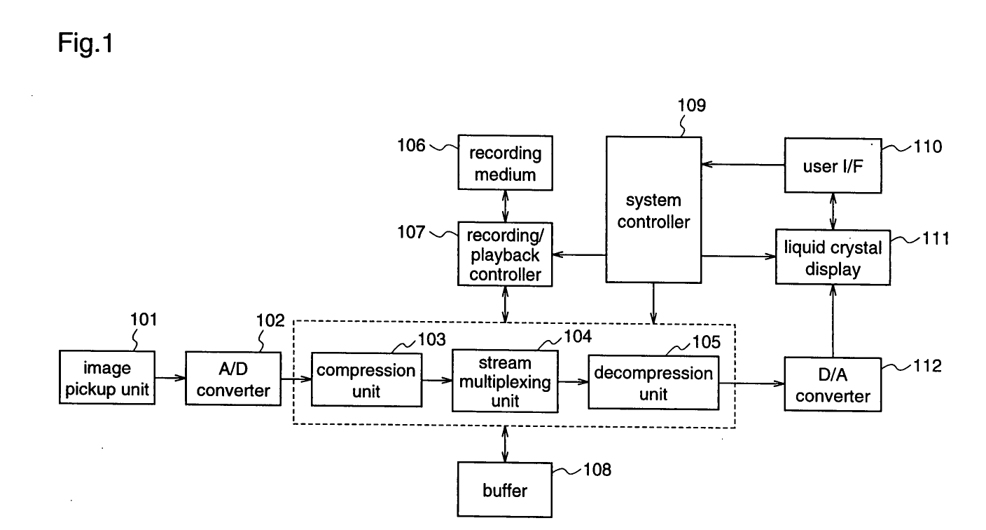

FIG. 1 is a block diagram illustrating the construction of an audio-visual recording/playback apparatus according to a first embodiment of the present invention.

In FIG. 1, an image pickup unit 101 is a well-known camera such as a CCD camera, and shoots an arbitrary location to continuously obtain shot pictures of the shooting target area.

An A/D converter 102 performs A/D conversion of an analog audio-visual signal obtained by the image pickup unit 101 to convert the analog signal into a digital audio-visual signal.

A compression unit 103 converts the digital audio-visual signal generated by the A/D converter 102 into an MPEG stream.

A stream multiplexing unit 104 performs multiplexing of the MPEG stream generated by the compression unit 103 and an MPEG stream of a still picture comprising only I pictures extracted from the MPEG stream generated by the compression unit 103, according to a multi-angle mode based on the DVD video standard.

A decompression unit 105 performs decompression of the MPEG streams, and it is provided with a function of performing graphics display such as OSD (On Screen Display).

A recording medium 106 is a random accessible recording medium for storing audio-visual streams, such as a CD, a DVD, an HDD, or an SD card.

A recording/playback controller 107 designates a recording address when recording an MPEG stream in the recording medium 106, and designates a reading address when reading an MPEG stream from the recording medium 106, thereby enabling recording and playback of MPEG streams.

A buffer 108 temporarily stores the MPEG stream generated in the compression unit 103 (hereinafter referred to as a normal moving picture stream) so that the user can extract I pictures as candidates for a still picture to be used for multi-angle from the MPEG stream (normal moving picture stream) which has been obtained by converting the analog audio-visual signal shot by the image pickup unit 101 into the digital audio-visual signal by the A/D converter and compressed by the compression unit 103. The buffer 108 may be a memory for temporary storage such as an SDRAM, or a CD, a DVD, an HDD, or an SD card to be used as the recording medium 106.

A system controller 109 manages recording of audio-visual streams, and sends control codes to the compression unit 103, the stream multiplexing unit 104, the decompression unit 105, the recording/playback controller 107, and an liquid crystal display 111, and further, manages the states of the compression unit 103, the stream multiplexing unit 104, the decompression unit 105, the recording/playback controller 107, and the liquid crystal display 111.

A user I/F 110 notifies the system controller 109 of a code corresponding to user operation performed to the audio-visual recording/playback apparatus. For example, the user I/F 110 notifies the system controller 109 of an operation code of user operation on a touch panel of the audio-visual recording/playback apparatus, or notifies the system controller 109 of an operation code of user's remote control on the audio-visual recording/playback apparatus, or notifies the system controller 109 of an operation code of user's directly pressing a button on the audio-visual recording/playback apparatus.

The liquid crystal display 111 displays video that is currently recorded on the recording medium 106, or plays and displays video signals already recorded on the recording medium 106, or displays an OSD for the user to operate the audio-visual recording/playback apparatus. Further, the display 111 is compatible with a touch panel.

A D/A converter 112 converts the digital audio-visual signal decompressed by the decompression unit 105 into an analog audio-visual signal to be output.

Hereinafter, a description will be given of the operation and function of the audio-visual recording/playback apparatus constructed as described above.

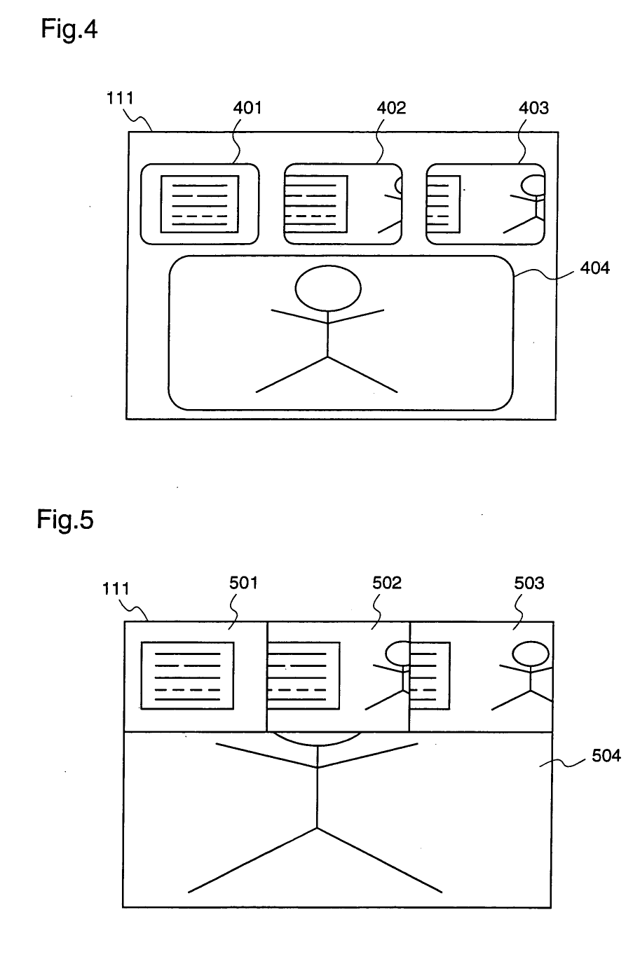

Initially, an audio-visual signal which is obtained by shooting an arbitrary location, person or the like by the image pick-up unit 101 is input to the A/D converter 102. The audio-visual signal inputted to the A/D converter 102 is converted into a digital audio-visual data and then the digital audio-visual data is compressed into an MPEG stream by the compression unit 103, whereby a normal moving-picture stream is generated and temporarily stored in the buffer 108. The buffer 108 is a ring buffer in which the normal moving-picture stream is sequentially stored. At the same time, the normal moving-picture stream is decompressed by the decompression unit 105 and displayed on the liquid crystal display 111. Further, a plurality of I pictures are extracted at predetermined time intervals from the normal moving-picture stream stored in the buffer 108, and the plural I pictures are respectively decompressed by the decompression unit 105, thereby generating candidates for a still picture to be multiplexed with the normal moving-picture stream by the stream multiplexing unit 104. Then, as shown in FIG. 4, the moving picture 404 which is obtained by decompressing the normal moving-picture stream by the decompression unit 105 and the candidate still pictures in sub-screens 401 to 403 are simultaneously displayed on the liquid crystal display 111.

As shown in FIG. 5, the candidate still pictures 501 to 503 may be superimposed by OSD or the like on the moving picture 504 that is obtained by decompressing the normal moving-picture stream by the decompression unit 105, and these pictures may be simultaneously displayed on the liquid crystal display 111.

Further, a plurality of I pictures at points in time when scene change occurs may be extracted and decompressed by the decompression unit 105 to generate candidate still pictures. Alternatively, a silent period is detected, and I pictures which are obtained by a predetermined period earlier than the silent period, or I pictures obtained during the silent period, or I pictures which are obtained by a predetermined period later than the silent period may be decompressed by the decompression unit 105 to generate candidate still pictures. Alternatively, using a zoom unit for performing zoom operation including zoom-in and zoom-out, I pictures which are obtained by a predetermined period earlier than start of the zoom operation, or I pictures obtained during the zoom operation, or I pictures which are obtained by a predetermined period later than the zoom operation may be decompressed by the decompression unit 105 to generate candidate still pictures.

In the above description, when the moving picture obtained by decompressing the normal moving picture stream with the decompression unit 105 is displayed on the liquid crystal display 111, OSD is applied to the moving picture which has once been compressed into an MPEG stream by the compression unit 103 and then decompressed by the decompression unit, and the moving picture thus obtained is displayed on the liquid crystal display 111. However, OSD may be directly applied to the digital audio-visual data outputted from the A/D converter 102, which is not subjected to compression and decompression, and the audio-visual data may be displayed on the liquid crystal display 111.

Next, the user selects one still picture from among the plural candidate still pictures displayed on the liquid crystal display 111. The selected still picture is a still picture to be multiplexed into the normal moving picture stream. The user may select one still picture from a liquid crystal screen corresponding to a touch panel, or the user may select one still picture using a remote controller or a button that is provided on the audio-visual recording apparatus. When the audio-visual recording apparatus is provided with a function for directly capturing still pictures from the outside, such as a shutter, the user can directly capture a still picture by pressing the shutter, and the captured still picture may be a still picture to be multiplexed in the normal moving picture stream. Further, when the audio-visual recording apparatus is provided with a function of directly capturing still pictures from the outside using a memory card such as an SD card, a still picture that is directly captured from the memory card may be multiplexed in the normal moving picture stream. Furthermore, when the audio-visual recording apparatus is provided with a function of USB connection or line input, a still picture may be directly captured from the outside using the USB or the line input, and the captured still picture may be a still picture to be multiplexed in the normal moving picture stream.

Next, the user I/F 110 notifies the system controller 109 of the information of the still picture selected by the user. Then, an MPEG stream of the selected still picture (hereinafter referred to as a still picture stream) is generated from the I picture of the still picture, and the still picture stream and the normal moving picture stream stored in the buffer 108 are multiplexed by the stream multiplexing unit 104, and the multiplexed stream is recorded on the recording medium 106 through the recording/playback controller 107. The time of the normal moving picture stream at which the multiplexing is started is the time of the I picture corresponding to the still picture selected by the user. Alternatively, when performing multiplexing of the still picture stream and the normal moving picture stream, the time of the normal moving picture stream at which the multiplexing is started may be the time at which the user selects the still picture. Further, as for the audio inserted into the still picture stream to be multiplexed, the audio used in the normal moving picture stream may be used as it is to generate a still picture stream to be multiplexed.

While in this first embodiment one still picture stream is multiplexed, nine streams at maximum including normal moving picture streams and still picture streams can be multiplexed simultaneously because the multi-angle function based on the DVD video standard is utilized for multiplexing.

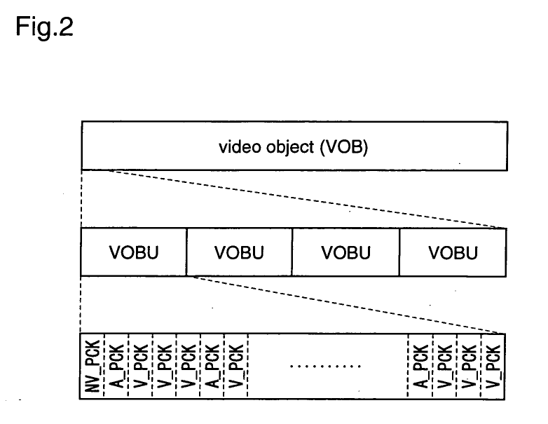

Hereinafter, generation of still picture streams will be described with reference to FIG. 2.

A video object (VOB) shown in FIG. 2 is composed of a group of video object units (VOBU). Each VOBU is composed of a group of navigation pack (NV_PCK), video packs (V_PCK), and audio packs (A_PCK). The NV_PCK, V_PCK, and A_PCK include navigation data, video data, and audio data, respectively. The video data is a video elementary stream compressed according to the MPEG, which is usually composed of I pictures, P pictures, and B pictures. The audio data is an audio elementary stream compressed according to an audio compression format. When generating a still picture stream from I pictures, only the data of the I pictures are inserted in the video data in the V_PCK, and the same audio data as those used in the normal moving picture stream are used to generate a still picture stream.

As described above, it is possible to generate a still picture stream and a normal moving picture stream from one input, and multiplex these streams to be recorded on the recording medium 106.

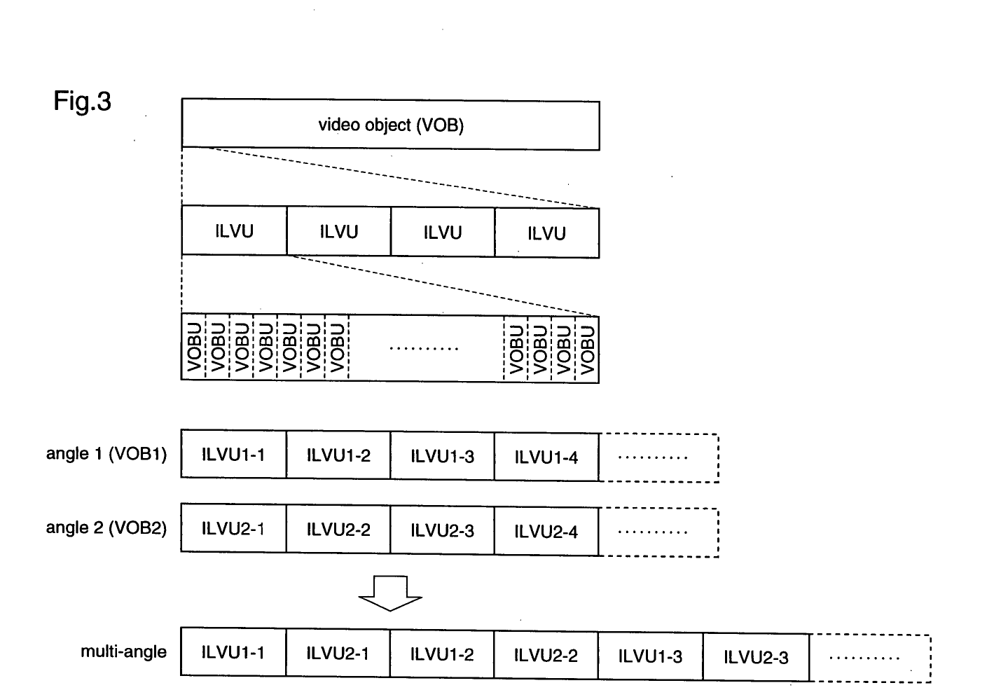

Next, a description will be given of the construction of a stream to be multiplexed by the stream multiplexing unit 104 shown in FIG. 1, with reference to FIG. 3. The audio-visual recording/playback apparatus according to the first embodiment performs multiplexing of MPEG streams so as to realize multi-angle playback based on the DVD video standard, which enables the user to view video with the angle of video being changed as desired while playing audio as it is.

FIG. 3 shows a stream multiplexing format employed in the audio-visual recording/playback apparatus according to the first embodiment, wherein a data structure used when multi-angle playback is actually carried out is illustrated. Although the data structure used when multi-angle playback is carried out will be briefly described hereinafter, details are described in the DVD video standard.

In order to realize multi-angle, a VOB should be composed of a group of interleaved units (ILVU). Each ILVU is composed of a group of VOBUs described above.

A description will be given of the data structure in the case where plural VOBs of different angles are actually multiplexed. For example, each of two VOBs, i.e., VOBs of scenes of angle 1 and angle 2, is divided into plural interleaved units (ILVU). Next, the angle 1 and the angle 2 are multiplexed for each ILVU, thereby constituting multi-angle data.

Next, a description will be given of a display method of the liquid crystal display 111 of the audio-visual recording/playback apparatus according to the present invention, with reference to FIGS. 1 and 4.

FIG. 4 shows the detail of the liquid crystal display of the audio-visual recording/playback apparatus according to the first embodiment, illustrating a moving picture obtained by decompressing a normal moving picture stream by the decompression unit 105, and candidate still pictures on different screens on the liquid crystal display 111 at the same time.

With reference to FIG. 4, the candidate still pictures displayed on the sub-screens 401, 402, and 403 are obtained by extracting plural I pictures at regular intervals from the normal moving picture stream stored in the buffer 108, and decompressing the I pictures. While in FIG. 4 three still pictures are displayed, an arbitrary number of still pictures can be displayed. The normal screen 404 displays video which is obtained by compressing and decompressing the video currently taken by the image pickup unit 101. The user selects a still picture for which multi-angle recording is desired, from among the candidate still pictures displayed on the sub-screens 401, 402, and 403. For example, when the user selects the still picture displayed on the sub-screen 401, the still picture stream of the still picture on the sub-screen 401 and the normal moving picture stream are multiplexed to perform multi-angle recording from the time when the still picture on the sub-screen 401 is taken, thereby performing multi-angle recording. The multi-angle recording comprises compressing the video which is currently taken and the corresponding audio, and the still picture which is selected from among the I pictures extracted at regular intervals from the normal moving picture stream or the still picture which is directly captured from the outside and the corresponding audio, and recording the compressed video and audio on the recording medium 106.

FIG. 5 is a diagram illustrating the detail of the liquid crystal display of the audio-visual recording/playback apparatus according to the first embodiment. In the display method of the liquid crystal display 111, the candidate still pictures 501 to 503 are superimposed by OSD or the like on the moving picture 504 that is obtained by decompressing the normal moving picture stream with the decompression unit 105. Since this operation is identical to the operation already described with respect to FIG. 4, repeated description is not necessary.

Next, the data structure according to the first embodiment will be described with reference to FIGS. 1, 3, and 4.

For example, it is assumed that the user selects the sub-screen 401 shown in FIG. 4. In this case, the angle 1 (VOB1) shown in FIG. 3 is composed of a normal moving picture stream corresponding to the moving picture displayed in the normal screen 404. The angle 2 (VOB2) is composed of a still picture stream corresponding to the still picture displayed in the sub-screen 401 selected by the user, and the audio stream is composed of the same audio stream as that of the angle 1. The data of the angle 2 is constituted so that the I-picture video data is inserted for each ILVU of the angle 2 so that playback of the still picture can be normally carried out. A multi-angle stream is constituted by multiplexing the angle 1 and the angle 2.

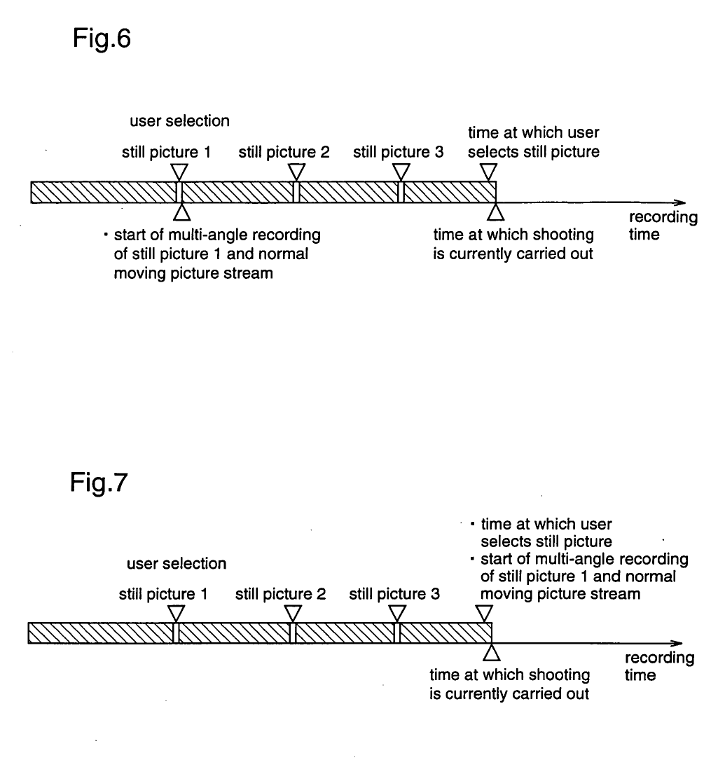

FIG. 6 is a conceptual diagram illustrating the flow of time in the case where multi-angle recording is started from a time before to the time at which the user selects the still picture, when performing multi-angle recording by the audio-visual recording/playback apparatus according to the first embodiment.

A description will be given of the start point of multi-angle recording, with reference to FIGS. 1, 4, and 6.

The diagonally shaded area in FIG. 6 shows the normal moving picture stream stored in the buffer 108, and the still picture 1 is displayed on the sub-screen 401, the still picture 2 is displayed on the sub-screen 402, and the still picture 3 is displayed on the sub-screen 403. For example, when the user selects the still picture 1, the still picture stream of the still picture 1 and the normal moving picture stream that is temporarily stored in the buffer 108 are multiplexed from the time when the still picture 1 is taken, thereby performing multi-angle recording.

Further, FIG. 7 is a conceptual diagram illustrating the flow of time in the case where multi-angle recording is started from the time at which the user selects the still picture, when performing multi-angle recording by the audio-visual recording/playback apparatus according to the first embodiment.

A description will be given of the start point of multi-angle recording, with reference to FIGS. 1, 4, and 7.

The diagonally shaded area in FIG. 7 shows the normal moving picture stream stored in the buffer 108, and the still picture 1 is displayed on the sub-screen 401, the still picture 2 is displayed on the sub-screen 402, and the still picture 3 is displayed on the sub-screen 403. For example, when the user selects the still picture 1, the still picture stream of the still picture 1 and the normal moving picture stream that is temporarily stored in the buffer 108 are multiplexed from the time when the user selects the still picture 1, thereby performing multi-angle recording.

While in this first embodiment two examples are described as for the starting points of multi-angle recording, multi-angle recording may be started at any point in time of the normal moving picture stream that is temporarily stored in the buffer 108.

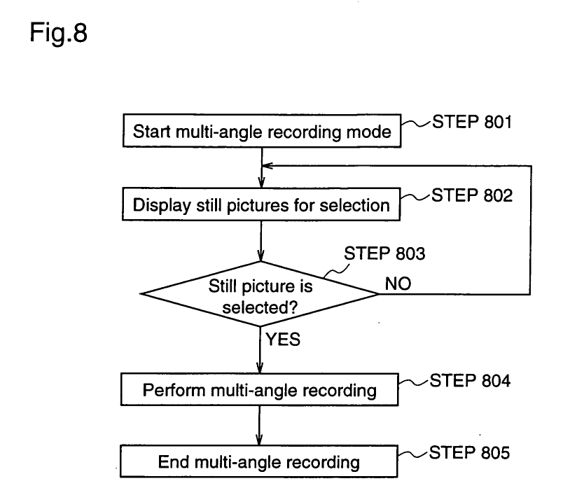

FIG. 8 is a flowchart when performing multi-angle recording by the audio-visual recording/playback apparatus according to the first embodiment.

The audio-visual recording/playback apparatus according to the first embodiment of the present invention is provided with a multi-angle mode, and enables multi-angle recording by selecting the multi-angle mode.

In FIG. 8, initially, when the user selects the multi-angle mode in STEP 801, candidate still pictures to be selected by the user are displayed on the liquid crystal display 111 in STEP 802. Next, in STEP 803, the user selects a still picture to be used for multi-angle recording from among the candidate still pictures displayed on the liquid crystal display (“Yes” in STEP 803). Next, in STEP 804, the still picture stream of the still picture selected by the user and the normal moving picture stream are multiplexed to perform multi-angle recording. When the user selects no still picture from among the candidate still pictures in STEP 803 (“No” in STEP 803), the still pictures for selection in STEP 2 are displayed again. In STEP 805, the multi-angle recording is ended by the user. In this way, multi-angle recording is carried out.

Even when the user selects no still picture, normal recording is continued. The normal recording comprises compressing only the video and audio which are currently taken without performing multiplexing, and recording the compressed video and audio on the recording medium 106.

While in this first embodiment the audio-visual recording/playback apparatus having the image pickup unit 101 is described as an example, the present invention is also applicable to an audio-visual recording/playback apparatus having no image pickup unit, such as a DVD recorder, or to a digital video camera.

As described above, according to the audio-visual recording/playback apparatus of the first embodiment, plural streams are generated from one input, and the streams are multi-angle-recorded. Therefore, when playing recorded video and audio, the user can select and play his/her favorite video while playing audio as it is by using a common player such as a DVD player.

### APPLICABILITY TN INDUSTRY

An audio-visual recording/playback apparatus and a digital video camera according to the present invention can generate plural streams from one input and perform multi-angle recording of the streams. Therefore, the apparatus and the camera are useful in an audio-visual recording/playback apparatus that performs recording on a random accessible recording medium.

1. An audio-visual recording/playback apparatus having an input means for capturing an audio-visual signal, comprising:
a stream generation unit for generating plural streams using one audio-visual signal inputted by the input means;
a multiplexing unit for multiplexing at least two streams among the plural streams to generate a multiplexed stream; and
a recording unit for recording the multiplexed stream.

2. An audio-visual recording/playback apparatus having an input means for capturing an audio-visual signal, comprising:
a stream generation unit for generating plural streams using one audio-visual signal inputted by the input means;
a multiplexing unit for multiplexing the plural streams to generate a multiplexed stream;
a recording unit for recording the multiplexed stream; and
said stream generation unit generating the plural streams as those using the same audio.

3. An audio-visual recording/playback apparatus as defined in claim 1, comprising:
said stream generation unit
generating, as one of the plural streams, a first stream using a normal moving picture of the audio-visual signal inputted by the input means, and
generating, as another one of the plural streams, a second stream using still pictures of the audio-visual signal inputted by the input means; and
said multiplexing unit multiplexing the first stream and the second stream which are generated by the stream generation unit.

4. An audio-visual recording/playback apparatus as defined in claim 1, comprising:
said stream generation unit
generating, as one of the plural streams, a first stream using a normal moving picture of the audio-visual signal inputted by the input means, and
generating candidate still pictures from the first stream, and generating, as another one of the plural streams, a second stream using a still picture selected from among the candidate still pictures; and
said multiplexing unit multiplexing the first stream and the second stream which are generated by the stream generation unit.

5. An audio-visual recording/playback apparatus as defined in claim 4, wherein said candidate still pictures are still pictures which are extracted at predetermined time intervals from the stream generated using the normal moving picture of the audio-visual signal.

6. An audio-visual recording/playback apparatus as defined in claim 4, wherein said candidate still pictures include still pictures at points in time when the scene of the stream generated using the normal moving picture of the audio-visual signal changes.

7. An audio-visual recording/playback apparatus as defined in claim 4, wherein said candidate still pictures are still pictures which are obtained by a predetermined time earlier than a silence period of the stream generated using the normal moving picture of the audio-visual signal, or still pictures obtained during the silence period, or still pictures which are obtained by a predetermined time later than the silence period.

8. An audio-visual recording/playback apparatus as defined in claim 4 comprising:
a zoom unit for performing a zoom operation including zoom-in and zoom-out;
wherein said candidate still pictures are still pictures which are obtained by a predetermined time earlier than start of the zoom operation, or still pictures obtained during the zoom operation, or still pictures which are obtained by a predetermined time later than end of the zoom operation.

9. An audio-visual recording/playback apparatus as defined in claim 1 comprising:
a still picture capture unit for directly capturing still pictures from the outside; and
said stream generation unit
generating, as one of the plural streams, a first stream using a normal moving picture of the audio-visual signal inputted by the input means, and
generating, as another one of the plural streams, a third stream using the still pictures which are captured by the still picture capture unit; and
said multiplexing unit multiplexing the first stream and the third stream which are generated by the stream generation unit.

10. An audio-visual recording/playback apparatus as defined in claim 1 comprising:
a still picture capture unit for directly capturing still pictures from the outside; and
said stream generation unit
generating, as one of the plural streams, a first stream using a normal moving picture of the audio-visual signal inputted by the input means, and
generating candidate still pictures from the still pictures captured by the still picture capture unit, and generating, as another one of the plural streams, a third stream using a still picture selected from among the candidate still pictures; and
said multiplexing unit multiplexing the first stream and the third stream which are generated by the stream generation unit.

11. An audio-visual recording/playback apparatus as defined in claim 3, wherein said multiplexing unit multiplexes the first stream and the second stream, starting from a time when the still picture is generated from the audio-visual signal inputted by the input means.

12. An audio-visual recording/playback apparatus as defined in claim 9, wherein said multiplexing unit multiplexes the first stream and the third stream, starting from a time when the still picture is generated from the audio-visual signal inputted by the input means.

13. An audio-visual recording/playback apparatus as defined in claim 4, wherein said multiplexing unit multiplexes the first stream and the second stream, starting from a time when the still picture is selected from among the candidate still pictures.

14. An audio-visual recording/playback apparatus as defined in claim 10, wherein said multiplexing unit multiplexes the first stream and the third stream, starting from a time when the still picture is selected from among the candidate still pictures.

15. An audio-visual recording/playback apparatus as defined in claim 4, wherein said recording unit is able to record the still picture selected from among the candidate still pictures, and the stream generated from the still picture.

16. An audio-visual recording/playback apparatus as defined in claim 10, wherein said recording unit is able to record the still pictures captured by the still picture capture unit, and the stream generated from the still pictures.

17. A digital video camera having an input means for capturing an audio-visual signal, comprising:
a stream generation unit for generating plural streams using one audio-visual signal inputted by the input means;
a multiplexing unit for multiplexing the plural streams to generate a multiplexed stream;
a recording unit for recording the multiplexed stream; and
said stream generation unit generating the plural streams as those using the same audio.

18. An audio-visual recording/playback apparatus as defined in claim 2, comprising:
said stream generation unit
generating, as one of the plural streams, a first stream using a normal moving picture of the audio-visual signal inputted by the input means, and
generating, as another one of the plural streams, a second stream using still pictures of the audio-visual signal inputted by the input means; and
said multiplexing unit multiplexing the first stream and the second stream which are generated by the stream generation unit.

19. An audio-visual recording/playback apparatus as defined in claim 2, comprising:
said stream generation unit
generating, as one of the plural streams, a first stream using a normal moving picture of the audio-visual signal inputted by the input means, and
generating candidate still pictures from the first stream, and generating, as another one of the plural streams, a second stream using a still picture selected from among the candidate still pictures; and
said multiplexing unit multiplexing the first stream and the second stream which are generated by the stream generation unit.

20. An audio-visual recording/playback apparatus as defined in claim 2 comprising:
a still picture capture unit for directly capturing still pictures from the outside; and
said stream generation unit
generating, as one of the plural streams, a first stream using a normal moving picture of the audio-visual signal inputted by the input means, and
generating, as another one of the plural streams, a third stream using the still pictures which are captured by the still picture capture unit; and
said multiplexing unit multiplexing the first stream and the third stream which are generated by the stream generation unit.

21. An audio-visual recording/playback apparatus as defined in claim 2 comprising:
a still picture capture unit for directly capturing still pictures from the outside; and
said stream generation unit
generating, as one of the plural streams, a first stream using a normal moving picture of the audio-visual signal inputted by the input means, and
generating candidate still pictures from the still pictures captured by the still picture capture unit, and generating, as another one of the plural streams, a third stream using a still picture selected from among the candidate still pictures; and
said multiplexing unit multiplexing the first stream and the third stream which are generated by the stream generation unit.
